(19) United States
(12) Patent Application Publication
(10) Pub. No.: US 2003/0110474 A1
(43) Pub. Date: Jun. 12, 2003

(54) System for coverability analysis

(75) Inventors: Shmuel Ur, D. N. Misgav (IL); Gil Ratsaby, Nazereth (IL)

Correspondence Address: BROWDY AND NEIMARK, P.L.L.C., 624 NINTH STREET, NW, SUITE 300, WASHINGTON, DC, 20001-5303, US

(73) Assignee: INTERNATIONAL BUSINESS MACHINES CORPORATION, Armonk, NY (US)

(21) Appl. No.: 10/003,482

(22) Filed: Dec. 6, 2001

(51) Int. Cl. G06F 9/44; G06F 9/45

(52) U.S. Cl. 717/131; 717/154

(57) ABSTRACT

A method for performing coverability analysis in software, including performing a static analysis of software under test (SUT) so as to identify a plurality of dominating blocks in the SUT, formulating respective coverability tasks for the dominating blocks of the SUT and generating rules regarding behavior of the SUT corresponding respectively to the coverability tasks. The method further includes, for each of the rules, running a symbolic model checker to test a behavioral model of the SUT, so as to produce respective results for the rules, and computing a coverability metric for the SUT responsive to the results and the coverability tasks.

### FIELD OF THE INVENTION

The present invention relates generally to verifying software, and specifically to coverability analysis of software.

### BACKGROUND OF THE INVENTION

The purpose of verifying software is to provide an assurance that the software performs as specified, without defects. A plurality of methods for verifying software are known in the art and are divided into two categories: testing and formal verification.

In the context of the present patent application and in the claims, software and software under test will refer to programs written in programming languages known in the art, including hardware definition languages such as Verilog and VHDL.

Testing, according to the Free On-Line Dictionary of Computing (FOLDOC), which can be found at http://foldoc.doc.ic.ac.uk/foldoc and which is incorporated herein by reference, is defined as “[t]he process of exercising a product to identify differences between expected and actual behaviour.” Many different testing techniques and types are known in the art, including black-box testing, white-box testing, unit testing, system testing, and acceptance testing. In all testing, the software under test (SUT) executes under a variety of test conditions drawn from a test suite, often with the aid of simulators, until sufficient testing has been performed. Factors such as time constraints, cost constraints, and fault tolerance play a role in determining what constitutes sufficient testing. One common metric of testing thoroughness is coverage, which tracks completeness of a set of tests, with regard to ensuring that as many areas as possible of the SUT are tested.

FIG. 1 presents a schematic diagram of elements and processes involved in a process 19 for testing software under test (SUT) 10, as is known in the art. Initially, in a determine coverage model step 20, a coverage model is chosen. A number of coverage models are known in the art, referring to different ways of assessing coverage. For example, statement coverage considers a percentage of program statements executed over a test suite, functional coverage involves measuring a percentage of specified functions that a test suite exercised, and path coverage concerns how many different control-flow paths the tests caused the SUT to execute. In an establish coverage goals step 21 goals are identified according to the coverage model chosen in step 20, the goals both directing the creation of a set of tests and forming stopping criteria for the overall testing process. Coverage goals comprise metrics referring to the extent to which SUT 10 is exercised, for example, 95% statement coverage and/or 100% functional coverage. In a define coverage tasks step 22 a set of coverage tasks is generated to meet the coverage goals identified in step 21. The coverage tasks comprise a translation of the coverage goals into practical terms relative to SUT 10. For example, a coverage goal of 95% statement coverage engenders a plurality of coverage tasks of the form “execute statement #n,” where n is a number from 1 to the last statement in SUT 10.

In a build test suite step 28 a test suite is generated, comprising a plurality of test conditions 30 and a way of evaluating expected results 32. Test conditions 30 comprise input values and conditions intended to exercise the SUT and perform one or more coverage tasks. Ideally, plurality of test conditions 30 should perform all coverage tasks generated in step 22, although in practice it may be difficult to identify a complete set of test conditions a priori. An oracle function typically evaluates expected results, either via manual inspection by a human expert or via automatic comparison to predetermined expected results 32. In an execution step 24, a test harness loads a test condition from plurality of test conditions 30 and executes SUT 10. During execution, a measure coverage step 26 runs, to assess the coverage achieved during the test. Execution of SUT 10 produces actual results, responsive to the test conditions loaded from plurality of test conditions 30. The oracle function performs a comparison step 34 between actual results of execution 24 and expected results 32, and condition 36 determines the success or failure of the test. An outcome of failure generally indicates a defect in SUT 10, which requires developer attention in a debug step 38. A condition 40 checks whether sufficient testing of SUT 10 has completed, i.e., if results of measure coverage 25 accords with coverage goals 21. If coverage goals 21 have been accomplished, testing process 19 terminates.

If coverage goals 21 have not yet been achieved, testing process 19 continues in a condition 42 which checks if unexecuted tests remain in test suite 28. If tests remain, a next test condition is selected from test conditions 30, and execution step 24 again executes SUT 10 under the next test condition. If all tests in test suite 28 have executed without achieving coverage goals 21, it is necessary to augment test suite 28 with additional tests in an add tests to test suite step 44, and continue in execution step 24.

As distinct from the testing exemplified by process 19, formal verification does not execute tests against software under test. The National Institute of Standards and Technology, an agency of the U.S. Commerce Department's Technology Administration in Gaithersburg, Md., defines formal verification in its Dictionary of Algorithms, Data Structures, and Problems which can be found at http://www.nist.gov/dads and which is incorporated herein by reference, as “[e]stablishing properties of hardware or software designs using logic, rather than (just) testing or informal arguments. This involves formal specification of the requirement, formal modeling of the implementation, and precise rules of inference to prove, say, that the implementation satisfies the specification.” Different methods for formal verification are known in the art, including theorem proving and model checking. In the context of the present patent application and in the claims, formal verification refers to methods using model checking. In contrast to testing, formal verification operates on a model of the software and uses a model checker program to prove precisely-formulated rules. The rules are typically expressed in terms of temporal logic, describing a notation for expressing when statements are true.

In an article entitled Symbolic Model Checking without BDDs by Biere, Cimatti, Clarke, and Zhu, published by the School of Computer Science, Carnegie Mellon University, January 1999, which is incorporated herein by reference, the authors describe the applicability and utility of model checking: “Model checking is a powerful technique for verifying reactive systems. Able to find subtle errors in real commercial designs, it is gaining wide industrial acceptance. Compared to other formal verification techniques (e.g., theorem proving) model checking is largely automatic.” The authors go on to refer to a state-explosion problem: “In model checking, the specification is expressed in temporal logic and the system is modeled as a finite state machine. For realistic designs, the number of states of the system can be very large and the explicit traversal of the state space becomes infeasible.” State-explosion renders covering all states in a finite state machine infeasible.

Because of the state-explosion problem, many optimization techniques exist in the art in order to reduce the model checker's task to feasible proportions. For example, one optimization eliminates from the finite state machine all elements outside a cone of influence of a given rule. The cone of influence refers to variables and logic that may affect an outcome of the rule. Another optimization borrows the notion of basic blocks from compiler theory to reduce the work required of the model checker.

FIG. 2 is a schematic diagram of a process 50 comprising elements and processes involved in formal verification, as is known in the art. A create formal specification step 51 describes in precise terms the requirements for SUT 10, using methods known in the art. SUT 10 implements formal specification 51 and may comprise a complete program or a program fragment. Based on formal specification 51, in a compose formal rules step 52, formal specification 51 undergoes a translation into a plurality of formal rules 54, typically in the form of temporal logic, as is known in the art. The translation from formal specification 51 to formal rules 52 is accomplished by methods known in the art, including automatic generation and manual formulation of rules. Rules intended to verify the specification are typically stated in a positive form, so that proving the rule confirms the specification. Formal rules 54 express properties of the software design, such as every request message eventually receives an acknowledgement message, or counter c is always less than 5. Rules intended to reason about the behavior of a design are typically formulated in a negative form, so that disproving the rule confirms the behavior. For example, if the goal is to determine whether it is possible to execute a block of code Y in a given design, the corresponding rule would express the proposition that Y never executes. Disproving the rule signifies that Y does execute. In a select rule step 53, a single formal rule R is selected from the plurality of formal rules 54 and is presented to a symbolic model checker system 56, together with SUT 10. Symbolic model checker system 56 performs a number of activities on SUT 10 and the rule R. First, a compilation process 58 takes place wherein SUT 10 is transformed into a finite state machine (FSM) with respect to rule R. FSM 60 is the result of compilation process 58. It is important to note that the transformation focuses on the content of rule R, and may eliminate portions of SUT 10 from FSM 60, which are not relevant to rule R. Using FSM 60 and rule R as input, a model checker 62 computes the truth or falsity of rule R. Symbolic model checker system 56 contains an optional inflator 64 which expands the scope of the model checker output, as described in more detail below, with reference to FIG. 3. The output of the model checker is evaluated in an evaluate result step 66, which establishes either a confirmation of the truth of rule R or a counter-example illustrating the falsity of rule R.

In a condition 68, a predetermined stopping criterion is evaluated, e.g., have all formal rules 54 been submitted to model checker 56. If the stopping criteria are met, process 50 terminates. Otherwise, process 50 continues by selecting a next rule R from plurality of formal rules 54, in select formal rule step 53.

FIG. 3 is a schematic diagram presenting a typical result of an execution of a rule by a model checker, as is known in the art, and illustrates the effect of inflator 64 (FIG. 2) and the meaning of result 66. A model checker result 80 provides an example of result 66. In the case of a rule proven false, result 80 comprises a cycle-by-cycle trace of variables of interest in an execution of symbolic model checker system 56. A time axis 88 marks off time in cycles. Graphs 82, 84, and 86 display the values of variables A, B, and C respectively, over time. Assuming that rule R stipulates that a value of A cannot exceed A₂, i.e., !(A >A₂), model checker result 80 provides a counter-example illustrating that, at time tₙ, A held the value A₃. Since rule R in the example concerns only variable A, optimizations would typically eliminate other variables from FSM 60 outside of the cone of influence of A. Inflator 64 provides a way to include additional variables in the trace in result 80, by generating plausible values for additional variables. Inflator 64 sets input variables to random values, and computes values for additional values based on the random input variables and the contents of the counter-example. Thus, inflator 64 shows that, at time Tₙ, B had a value of B₀ and C had a value of C₀.

Some symbolic model checking systems comprise a witness function as well. The witness function supplies a trace similar to the counter-example described herein for the cases where a rule is proven true by the model checker. Inflator 64 operates in substantially the same way as described above, with respect to the witness output.

It will be noted that formal verification, by its nature, seeks to prove or disprove a rule on a model, without regard to the rarity of the counter-example. Formal verification concerns what is possible given an FSM and a rule. In contrast, testing and coverage measurements concern what actually happens when an SUT executes under a set of test conditions. Returning to FIG. 1, the thoroughness and completeness of test conditions 30 determine whether a specific coverage goal 21 is attained. Situations exist in which one or more coverage tasks 22 are impossible to perform, as in the following example of dead code:

| | |
|---|---|
| 1 | if (a > b \| \| c == 1) |
| 2 | { |
| 3 | intl = int2; |
| 4 | int2++; |
| 5 | } |
| 6 | else |
| 7 | if (c == 1) |
| 8 | { |
| 9 | int 2−−; |
| 10 | c = ; |
| 11 | } |

Statements 9 and 10 are dead code since it is not possible to execute them under any condition. If c==1, the first part of the “if” statement will execute (statements 3 and 4) and statements 9 and 10 will not execute. If c is not 1, then statement 7 will evaluate to false and, again, statements 9 and 10 will not execute.

The testing concept of coverability combines ideas from testing and formal verification. Coverability refers to a measurement of the possibility of achieving a coverage goal. In a seminal article entitled “Coverability Analysis Using Symbolic Model Checking” by Ratzaby, Ur, and Wolfsthal, presented at CHARME 2001, the 11^{th} Advanced Research Working Conference on Correct Hardware Design and Verification Methods, in Livingston, Scotland, Sep. 4-7 2001, which is incorporated herein by reference, the authors introduce the notion of coverability, which distinguishes between “whether a model has been covered by some test suite and . . . whether the model can ever be covered by any test suite.” The authors present a method for implementing coverability analysis by applying techniques of symbolic model checking to the problem of determining whether a coverage task is feasible. Ratzaby, Ur, and Wolfsthal further describe some limitations of testing and coverage measurement as tools for software verification, including “Simulation Coverage Analysis is, by definition, an analysis of the test suite, rather than of the model under investigation. Therefore, it is essentially limited in its ability to provide deep insight into the model.”

A coverability model may be constructed by creating a coverability goal for every coverage goal 21 (FIG. 1) in coverage model 20. Table I below presents a comparison of coverage and coverability models, goals, tasks, and methods, taking statement coverage as an example:

TABLE I

| | Coverage | Coverability |
|---|---|---|
| Model | Statement coverage | Statement coverability |
| (type of | | |
| coverage | | |
| or covera- | | |
| bility) | | |
| Goal | 100% statement | 100% statement |
| | coverage | coverability |
| Signifi- | The test suite | it is possible (though |
| cance of | contains a collection | not necessarily |
| goal | of tests that cause | practical) to generate |
| | all statements in the | one or more tests |
| | SUT to execute at | which would cause all |
| | least once. | statements in the SUT |
| | (“Statement n did | to execute at least |
| | execute”) | once. |
| | | (“Statement n can |
| | | execute”) |
| Tasks | Execute stmt. #1 | Prove that: |
| | Execute stmt. #2 | stmt. #1 can execute |
| | Execute stmt. #3 | stmt. #2 can execute |
| | . . . | stmt. #3 can execute |
| | | . . . |
| Method | Create a collection | Run model checker |
| | of tests in a test | against an FSM |
| | suite to accomplish | generated from the SUT |
| | tasks | with rules |
| | | corresponding to tasks |

It is appreciated that the possibility of reaching a certain statement is also a function of assumptions made about possible input values. The term “environment modeling” refers to ways of representing assumptions about inputs to the SUT. A free-behavior environment model allows an input to assume any legal value for its data type. A more restricted environment model could limit values to a narrow range, because of reasoning about the behavior of the input or simplifications aimed at reducing the state-space.

Formal verification is a powerful tool; however, it has a number of drawbacks as well which hamper its broader application to software development. The aforementioned state-explosion problem makes formal verification infeasible in cases of complex programs. In cases where formal verification is possible, model checkers often run slowly and inefficiently. Lastly, the use of esoteric temporal logic requires a proficiency specific to a relatively small group of experts in the field of formal verification, but extremely uncommon among software developers.

By combining concepts of coverage and model checking, the notion of coverability enhances the application of formal verification to software development. As described by Ratzaby, et al., coverability analysis is simpler than formal verification since temporal logic is not required and many rules are written automatically. Also, coverability analysis offers a number of advantages over coverage analysis:

portions of the code may be analyzed, without waiting for the program to be complete.

a simulation and/or test harness need not be developed.

tests are created automatically.

the analysis is exhaustive and is related to properties of the program, not functions of test conditions in a test suite.

As noted earlier, some optimizations in model checking borrow concepts from compiler theory. These concepts are known in the art, and include a basic block—a set of one or more statements within the same control-flow construct. Another useful, related concept is that of dominating blocks, including pre-dominating and post-dominating blocks. In the context of the present patent application and in the claims, a block X is said to pre-dominate a block Y if, in order to execute block Y, block X must always execute before. Block X is said to post-dominate block Y if, given execution of block X, block Y must always execute after. In the context of the present patent application and in the claims, the term “dominating block” refers to a block X which post-dominates a block Y, and the term “dominated block” refers to a block Y that is post-dominated by a block X.

Reference is now made to FIG. 4 which is a flowchart illustrating a flow of control among basic blocks, as is known in the art. SUT 10 is assumed to comprise basic blocks A, B, C, D, and E. Block A executes in every execution of SUT 10, as do Blocks D and E. However, Block A contains conditional logic, e.g., an “if” statement, that causes either Block B or Block C to execute in a given run of SUT 10, depending on the outcome of the conditional logic. Thus, Block A dominates itself (by definition), Block D, and Block E, meaning that if A executes, D and E must also execute. Blocks A, D, and E are dominated by Block A. Table II below presents the dominating blocks in SUT 10:

TABLE II

| | | Dominates: |
|---|---|---|
| Block | Pre-dominates: | (Post-dominates) |
| A | {A, B, C, D, E} | {A, D, E} |
| B | {A, B} | {B, D, E} |
| C | {A, C} | {C, D, E} |
| D | {A, D} | {D, E } |
| E | {A, D, E} | {E } |

A subset cover problem, as is known in the art, may be solved on a set of dominating blocks. Solving the subset cover problem produces a subset T that covers all the basic blocks in SUT 10, i.e., if every basic block in subset T executes, all basic blocks in SUT must execute. By inspecting the preceding table, it is noted that {B, C} comprise such a subset, since, if Blocks B and C execute, Blocks A, D, and E must of necessity also execute.

Algorithms are known in the art for the solution of the subset cover problem, which is considered an NP-complete problem, i.e., a class of problems for which a proposed solution can be confirmed or refuted quickly, though it may not be easy to find an optimal solution. One such example is the Greedy Algorithm, which selects a block with the largest set of dominated blocks, constructs a list of covered blocks, and repeats the process until the list of covered blocks contains each block in the SUT.

### SUMMARY OF THE INVENTION

In preferred embodiments of the present invention, a method for optimizing coverability analysis is defined. The method comprises utilizing information from a static analysis of dominating blocks of software under test (SUT), utilizing information from a dynamic analysis of model checker results, and/or combining information from the static and the dynamic analyses. The method provides greater benefit from fewer executions of a symbolic model checker, compared to other systems known in the art, thereby running faster by an estimated factor of between two and ten.

In some preferred embodiments of the present invention, the static analysis identifies a set of dominating blocks in the SUT. A list of coverability tasks responsive to the set of dominating blocks is defined. Preferably, the SUT is instrumented to facilitate definition of the coverability tasks, i.e., code is added to the SUT so that the coverability tasks may be defined more easily. For each task in the list in turn, a rule is generated and presented to the symbolic model checker, together with the SUT. Most preferably, the rule takes the form !(T), signifying “It is not possible to accomplish task T.” The symbolic model checker produces a result which proves or disproves the truth of the rule. If the rule is disproved, the respective coverability task is considered confirmed. The process of checking coverability continues until all coverability tasks in the list have been treated.

In some preferred embodiments of the present invention, a list of coverability tasks for the SUT is defined, responsive to the coverability goals defined for the SUT. Preferably, the SUT is instrumented to facilitate definition of the coverability tasks. For a randomly selected task in the list, a rule is generated. In some preferred embodiments of the present invention, the set of dominating blocks identified in the static analysis is used to direct selection of a task from the list of coverability tasks. For the selected task, a rule is generated. The rule is presented to the symbolic model checker, together with the SUT. The symbolic model checker produces a result which proves or disproves the truth of the rule. If the rule is disproved, signifying that the respective coverability task is confirmed, inflated variables from a counter-example produced by the model checker inflator are used to remove additional coverability tasks from the original list of coverability tasks. If the rule is proven true, the inflator is executed, with respect to witness output. The process continues until all coverability tasks remaining in the list have been handled.

Unlike other methods known in the art for optimizing coverability analysis, in preferred embodiments of the present invention:

the number of executions of the symbolic model checker is decreased because coverability of a dominating block assures coverability of all dominated blocks;

utilization of inflator output improves how quickly coverability tasks can be checked, and also results in fewer executions of the symbolic model checker; and

directing selection of the next task to check by using the results of the static analysis promotes a faster reduction of the coverability task list.

There is therefore provided, according to a preferred embodiment of the present invention, a method for performing coverability analysis in software, including performing a static analysis of software under test (SUT) so as to identify a plurality of dominating blocks in the SUT, formulating respective coverability tasks for the dominating blocks of the SUT and generating rules regarding behavior of the SUT corresponding respectively to the coverability tasks. The method further includes, for each of the rules, running a symbolic model checker to test a behavioral model of the SUT, so as to produce respective results for the rules, and computing a coverability metric for the SUT responsive to the results and the coverability tasks.

Preferably, the method includes writing the SUT in a programming language adapted to define at least one of a group of elements including a software element and a hardware element.

Preferably, performing the static analysis of the SUT includes identifying a set of dominating blocks in the SUT and solving a subset cover problem on the set of dominating blocks so as to identify the plurality of dominating blocks.

Further preferably, the set of dominating blocks includes a set of all dominating blocks in the SUT, and the plurality of dominating blocks includes fewer blocks than the set of all dominating blocks in the SUT.

Further preferably, running the symbolic model checker includes performing a number of executions of the symbolic model checker smaller than a total number of all the dominating blocks in the SUT.

Preferably, formulating the respective coverability tasks for the dominating blocks of the SUT includes formulating coverability tasks by at least one of a group of methods including manual formulation and automatic formulation.

Preferably, generating the rules regarding behavior of the SUT includes generating rules by at least one of a group of methods including manual generation and automatic generation.

Preferably, running the symbolic model checker to test the behavioral model of the SUT includes evaluating the respective results so as to determine the truth or falsity of the rule and generating a list of uncoverable elements responsive to the respective results.

Preferably, generating the rules regarding behavior of the SUT corresponding respectively to the coverability tasks includes instrumenting the SUT by adding one or more statements and one or more auxiliary variables thereto, so as to facilitate evaluation of the rules.

Further preferably, instrumenting the SUT includes determining a plurality of basic blocks included in the SUT and, for each basic block, defining an auxiliary variable for the block, initializing the auxiliary variable to zero, and assigning the auxiliary variable a non-zero value upon execution of the basic block.

Preferably, computing the coverability metric includes evaluating an attained coverability responsive to the respective results produced by running the symbolic model checker, evaluating an unattained coverability responsive to the respective results produced by running the symbolic model checker, performing a comparison between the attained coverability and the coverability tasks, calculating the coverability metric responsive to the comparison, and analyzing the behavioral model of the SUT with respect to the unattained coverability.

Preferably, the method includes analyzing a design of the SUT, responsive to the coverability metric, for at least one of a group of properties including dead code, unattainable states, uncoverable statements, uncoverable states, unattainable transitions, unattainable variable values, and unreachable conditions.

Preferably, the method includes applying a testing strategy chosen from one of a group of strategies including excluding uncoverable elements from coverage measurements, setting coverage goals responsive to the coverability metric, and determining a criterion for stopping testing responsive to the coverability metric.

Further preferably, the uncoverable elements include one or more elements chosen from a group of elements including uncoverable statements, uncoverable states, unattainable transitions, unattainable variable values, and unreachable conditions.

Preferably, formulating the respective coverability tasks for the dominating blocks of the SUT includes identifying a coverage model for the SUT, defining a coverability model for the SUT responsive to the coverage model, and generating the respective coverability tasks responsive to the coverability model.

There is further provided, according to a preferred embodiment of the present invention, a method for performing coverability analysis in software, including formulating first and second coverability tasks for software under test (SUT), generating a rule regarding behavior of the SUT corresponding to the first coverability task, running a symbolic model checker including an inflator to test a behavioral model of the SUT responsive to the rule so as to produce an inflated result, and evaluating the second coverability task responsive to the inflated result.

Preferably, formulating the second coverability task includes choosing a plurality of coverability tasks from a set of all coverability tasks for the SUT, and evaluating the second coverability task includes evaluating the plurality.

Preferably, generating the rule regarding behavior of the SUT includes performing a static analysis of the SUT, including identifying a set of dominating blocks in the SUT and solving a subset cover problem on the set of dominating blocks so as to produce a plurality of dominating blocks, and selecting the first coverability task responsive to the plurality.

Further preferably, selecting the first coverability task includes identifying a greatest-influence dominating block having a largest set of dominated blocks included in the plurality and selecting the first coverability task responsive to the greatest-influence dominating block.

Further preferably, the set of dominating blocks includes a set of all dominating blocks in the SUT, and the plurality of dominating blocks includes fewer blocks than the number of all the dominating blocks.

Preferably, running the symbolic model checker includes performing a number of executions of the symbolic model checker, where the number of executions is smaller than a total number of coverability tasks for the SUT.

Preferably, the method includes writing the SUT in a programming language adapted to define at least one of a group of elements including a software element and a hardware element.

Preferably, formulating the first and second coverability tasks for the SUT includes formulating the tasks by at least one of a group of methods including manual formulation and automatic formulation.

Preferably, generating the rule regarding behavior of the SUT comprises generating the rule by at least one of a group of methods including manual generation and automatic generation.

Preferably, running the symbolic model checker includes evaluating the inflated result and determining the truth or falsity of the rule responsive to the evaluation.

Preferably, generating the rule includes instrumenting the SUT by adding one or more statements and one or more auxiliary variables thereto, so as to facilitate evaluation of the rule.

Further preferably, instrumenting the SUT includes determining a plurality of basic blocks included in the SUT and, for each basic block, defining an auxiliary variable for the block, initializing the auxiliary variable to zero, and assigning the auxiliary variable a non-zero value upon execution of the basic block.

Further preferably, instrumenting the SUT includes determining a plurality of basic blocks comprised in the SUT, defining a single auxiliary variable for the SUT, initializing the single auxiliary variable to zero, and assigning a unique non-zero value to the single auxiliary variable upon execution of each basic block.

Preferably, running the symbolic model checker includes producing the inflated result regardless of the truth or falsity of the rule.

Preferably, evaluating the second coverability task responsive to the inflated result includes evaluating an attained coverability responsive to the inflated result from running the symbolic model checker, evaluating an unattained coverability responsive to the respective results produced by running the symbolic model checker. Preferably, evaluating the second coverability task further includes comparing the attained coverability with a plurality of all coverability tasks for the SUT, calculating a coverability metric responsive to the comparison, and analyzing the behavioral model of the SUT with respect to the unattained coverability.

Further preferably, the method includes analyzing a design of the SUT, responsive to the coverability metric, for at least one of a group of properties including dead code, unattainable states, uncoverable statements, uncoverable states, unattainable transitions, unattainable variable values, and unreachable conditions.

Further preferably, the method includes applying a testing strategy chosen from one of a group of strategies including excluding uncoverable elements from coverage measurements, setting coverage goals responsive to the coverability metric, and determining a criterion for stopping testing responsive to the coverability metric.

Further preferably, the uncoverable elements include one or more elements chosen from a group of elements including uncoverable statements, uncoverable states, unattainable transitions, unattainable variable values, and unreachable conditions.

Preferably, running the symbolic model checker includes performing a plurality of executions of an inflator program so as to produce a plurality of inflated results and evaluating the second coverability task responsive to the plurality of inflated results.

Preferably, formulating the first and second coverability tasks for the SUT includes identifying a coverage model for the SUT, defining a coverability model for the SUT responsive to the coverage model, and generating the first and second coverability tasks responsive to the coverability model.

There is further provided, according to a preferred embodiment of the present invention, apparatus for performing coverability analysis in software, including a computing system which is adapted to perform a static analysis of software under test (SUT) so as to identify a plurality of dominating blocks in the SUT, formulate respective coverability tasks for the dominating blocks of the SUT, and generate rules regarding behavior of the SUT corresponding respectively to the coverability tasks. The apparatus further includes a computing system which is adapted to run a symbolic model checker to test a behavioral model of the SUT for each of the rules so as to produce respective results for the rules, and compute a coverability metric for the SUT responsive to the results and the coverability tasks.

There is further provided, according to a preferred embodiment of the present invention, apparatus for performing coverability analysis in software, including a computer system which is adapted to formulate first and second coverability tasks for software under test (SUT), generate a rule regarding behavior of the SUT corresponding to the first coverability task, run a symbolic model checker comprising an inflator to test a behavioral model of the SUT responsive to the rule so as to produce an inflated result, and evaluate the second coverability task responsive to the inflated result.

There is further provided, according to a preferred embodiment of the present invention, a computer software product for coverability analysis, including a computer-readable medium having computer program instructions recorded therein, which instructions, when read by a computer, cause the computer to perform a static analysis of software under test (SUT) so as to identify a plurality of dominating blocks in the SUT, formulate respective coverability tasks for the dominating blocks in the SUT, generate rules regarding behavior of the SUT corresponding respectively to the coverability tasks, run a symbolic model checker to test a behavioral model of the SUT for each rule so as to produce respective results for the rules, and compute a coverability metric responsive to the results and the coverability tasks.

There is further provided, according to a preferred embodiment of the present invention, a computer software product for performing coverability analysis in software, including a computer-readable medium having computer program instructions recorded therein, which instructions, when read by a computer, cause the computer to formulate first and second coverability tasks for software under test (SUT), generate a rule regarding behavior of the SUT corresponding to the first coverability task, run a symbolic model checker including an inflator to test a behavioral model of the SUT responsive to the rule so as to produce an inflated result, and evaluate the second coverability task responsive to the inflated result.

The present invention will be more fully understood from the following detailed description of the preferred embodiments thereof, taken together with the drawings, in which:

### BRIEF DESCRIPTION OF THE DRAWINGS

FIG. 1 presents a schematic diagram of elements and processes involved in a process for testing software under test (SUT), as is known in the art;

FIG. 2 is a schematic diagram of a process comprising elements and processes involved in formal verification, as is known in the art;

FIG. 3 is a schematic diagram presenting a typical outcome of an execution of a rule by a model checker, as is known in the art;

FIG. 4 is a flowchart illustrating a flow of control among basic blocks for a software under test, as is known in the art;

FIG. 5 is a flowchart showing a method for optimizing coverability analysis using a static analysis of dominating blocks, according to a preferred embodiment of the present invention; and

FIG. 6 is a flowchart showing a method for optimizing coverability analysis using a dynamic output from a model checker, according to a preferred embodiment of the present invention.

### DETAILED DESCRIPTION OF PREFERRED EMBODIMENTS

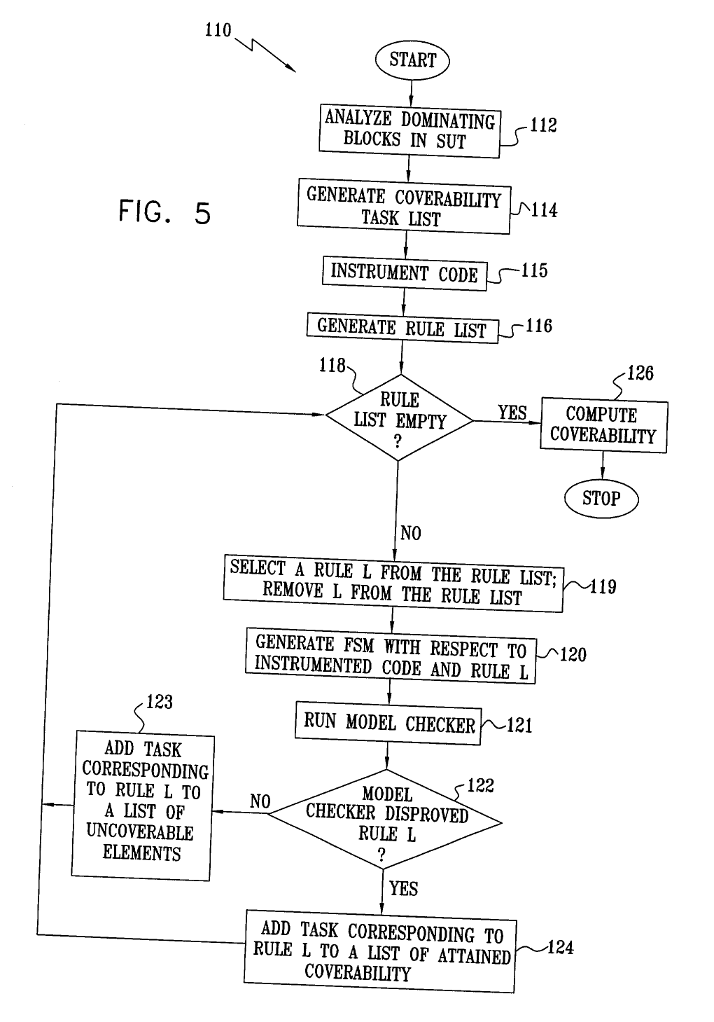

Reference is now made to FIG. 5, which is a flowchart showing a method 110 for optimizing coverability analysis using a static analysis of dominating blocks, according to a preferred embodiment of the present invention. Method 110 is implemented on any computer system, most preferably an industry-standard computer system, by reading instructions from a computer-readable medium such as a volatile or involatile memory. In an analysis step 112 a set S of dominating blocks for a software under test (SUT), for example SUT 10 (FIG. 4), is identified by methods known in the art. The set S comprises one or more sets of basic blocks such that each set contains a basic block and all blocks dominated by the basic block. Table II in the Background of the Invention presents the set S of dominating blocks for SUT 10. In Table II, it is seen, for example, that Block A dominates the set {A, D, E}, and Blocks A, D, and E are dominated by Block A. Thus, if Block A executes, Blocks D and E must also execute, since A, D, and E are dominated by Block A.

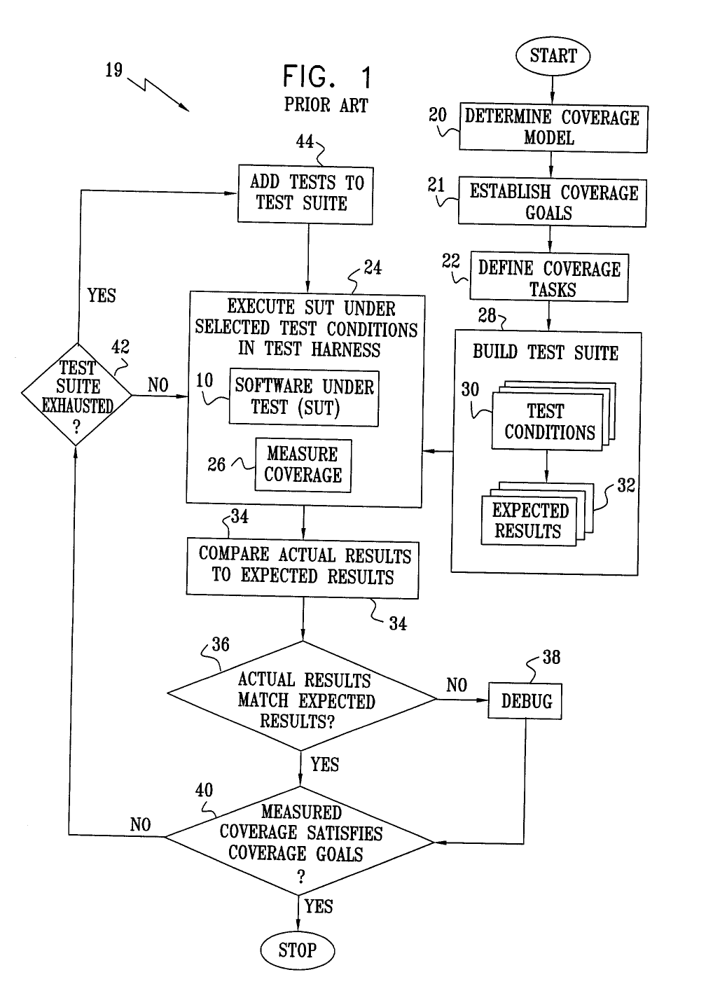

Analysis step 112 solves a subset cover problem on set S, by methods known in the art, to produce a subset T that covers all the basic blocks in SUT 10. A generate-coverability-task-list step 114 is performed, wherein a list of specific coverability tasks for SUT 10 is generated, substantially as described with reference to FIG. 1 and Table I hereinabove. An example of a coverability task for SUT 10 is “Block B can execute.” The coverability task list may be generated by automatic methods, manual methods, and/or a combination of automatic and manual methods, as are known in the art.

In an instrument step 115, statements are added to SUT 10 to facilitate formulation and execution of rules. Preferably, SUT 10 is instrumented by adding auxiliary variables which are used to indicate execution of blocks in subset T of dominating blocks, as determined in step 112. Preferably, a single auxiliary variable x is created, and x is assigned unique values in each basic block. Alternatively, a set of auxiliary variables, initialized to zero and corresponding to each basic block, is created. Each auxiliary variable is assigned a non-zero value upon execution of its respective block. Other methods for instrumenting SUT 10 will be apparent to those skilled in the art. Table IV hereinafter presents an example of a method of instrumentation.

A generate-list-of-rules step 116 is executed, wherein a rule is generated for each coverability task created in step 114, using instrumentation performed in step 115. Since the coverability task list was generated responsive to a subset of dominating blocks, i.e., subset T, created in step 112, it will be appreciated that the list of rules comprises a number of rules less than or equal to the number of basic blocks in SUT 10. In preferred embodiments of the present invention, the reduction attained in the number of rules is a function of the control-flow structure of SUT 10, and is approximately equal to a factor between two and ten. Preferably, rules are stated in negative terms, i.e., as a proposition to be refuted. For example, to check if variable A is ever equal to 1, a rule !(A ==1) stating that variable A never has the value 1 is constructed.

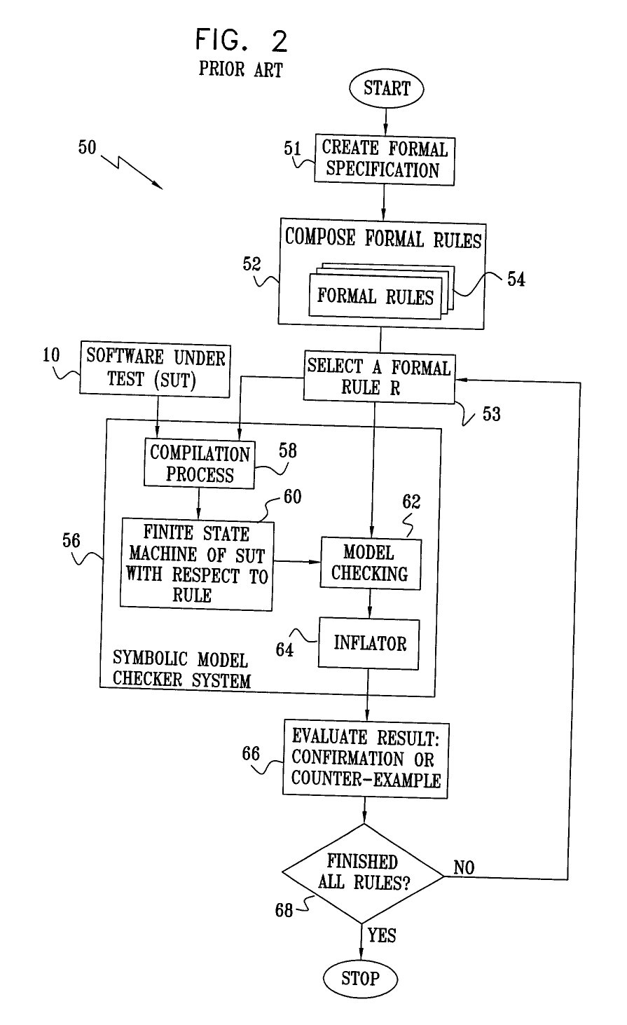

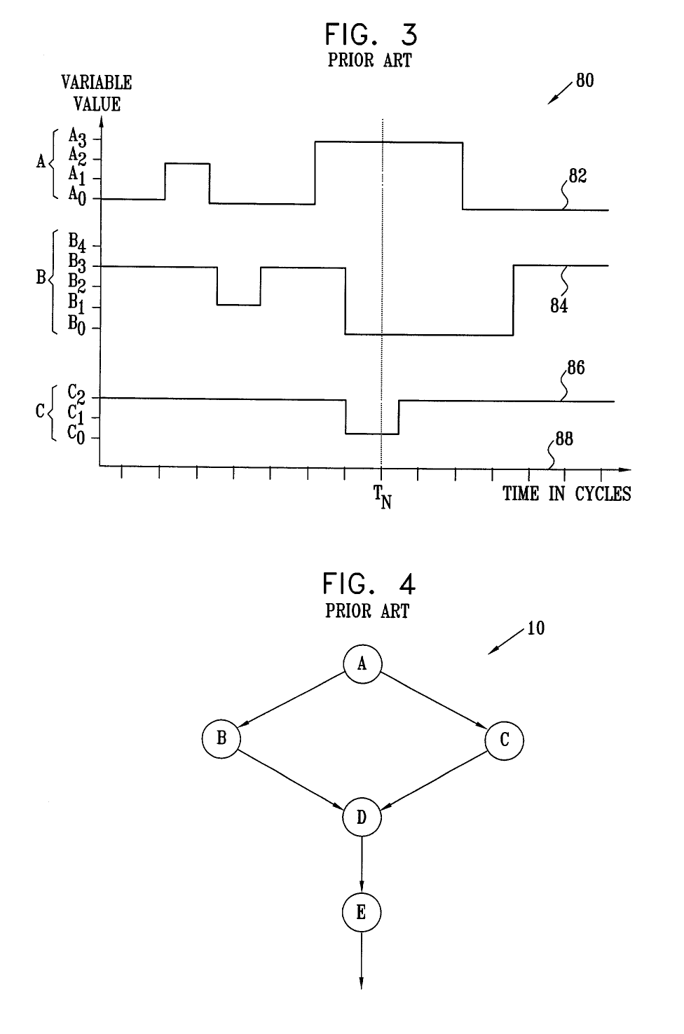

A condition 118 checks if the rule list, which originally contains at least one rule, is empty. If the rule list is not empty, a select rule step 119 is performed, wherein a single rule L is selected from the list generated in generate-list-of-rules step 116. In a generate FSM step 120, a finite state model is generated from SUT 10 instrumented code created in instrument code step 115 and rule L. FSM generation and execution is achieved substantially as described hereinabove with reference to symbolic model checker system 56 and included steps 58, 60, 62, and 64 in FIG. 2. In an execution step 121, the model checker focuses on proving or disproving rule L with respect to the FSM generated in generate FSM step 120. A condition 122 checks a result of symbolic model checker execution step 121, of the form presented in FIG. 3. If rule L is disproved, i.e., the proposition contained in rule L is found to be true, an add-to-attained-coverability step 124 adds the coverability task corresponding to rule L to a list of attained coverability tasks. If rule L is proven true, i.e., the proposition contained in the rule is found to be false, the coverability task corresponding to the rule is not attained. In an add-task-to-uncoverable elements step 123, the task is added to a list of uncoverable elements. Control returns to condition 118, wherein a next rule is selected and evaluated in the context of the FSM and symbolic model checker execution.

After all the rules in the rule list generated in step 116 have been submitted to the symbolic model checker in step 121, condition 118 detects that the rule list is empty, and control passes to a compute coverability step 126. Computing coverability comprises comparing the number of coverability tasks in the coverability task list generated in step 114 to the number of tasks in the list of attained coverability, as found in step 124. As well, the list of uncoverable elements generated in step 123 is available for evaluation by a developer. Method 110 terminates after step 126.

Coverability analysis comprises the coverability metric resulting from step 126 and the list of uncoverable elements resulting from step 123, and provides insights into design properties of SUT 10. The types of insights provided are a function of the coverability model in use. For example, in the case of statement coverability, coverability analysis indicates the existence of dead code. In the case of a model evaluating attainability of all values of a variable, the coverability metric indicates conditions such as incorrect variable definition (e.g., a variable defined as signed that can never have a negative value), or unused enumerated values. In a coverability model for a type of multi-condition coverage called multi-valued attainability checking of logical expressions, the coverability analysis indicates whether every atomic sub-formula can assume both Boolean values. For example, in the expression (X and (Y=2 or Z<6), the coverability metric indicates if X can be true and false, if (Y=2) can be both true and false, and if (Z<6) can be both true and false. If a sub-formula cannot achieve both Boolean values, it may indicate that logic is missing from the design. Additional insights based on the foregoing examples and other coverability models will be apparent to those skilled in the art.

Insights into SUT design properties gained from coverability analysis are used to improve design and direct testing strategies. It is appreciated that, in some cases, coverability of less than 100% is intentional. For example, dead code may exist to handle planned future modifications, not yet implemented. In such cases, the coverability metric provides a basis for excluding the dead code from coverage analysis. Thus, a test suite, which provides statement coverage for all statements except those identified as dead code by coverability analysis, can be considered to provide complete statement coverage. In other cases, incomplete coverability is unintentional, and points to omissions or errors in a design.

In the following example illustrating method 110, SUT 10 is assumed to comprise basic blocks {A, B, C, D, E} substantially as in the control-flow pictured in FIG. 4. Block A contains a conditional construct, as is known in the art, such as an “if” statement, which decides if execution passes to block B or block C.

For the purposes of the example, it is assumed that the coverage model for SUT 10 is statement coverage, and the coverage goal is 100% statement coverage. Since, by definition, if one statement of a basic block executes, all statements of the same basic block are assured of execution, statement coverage may be translated into basic block coverage. The complete set of coverability tasks for SUT 10 is presented in the Table III below:

TABLE III

| Number of | |
|---|---|
| coverability | Coverability Tasks |
| task | prove that: |
| 1 | Block A can execute |
| 2 | Block B can execute |
| 3 | Block C can execute |
| 4 | Block D can execute |
| 5 | Block F can execute |

Analysis step 112 generates the dominating blocks for SUT 10, as shown in Table II in the Background of the Invention. Also in step 112, solving the subset cover problem results in a set comprising {B, C}. Thus, executing blocks B and C assures execution of all remaining blocks in SUT 10, i.e., blocks A, D, and E. Generate-coverability-task-list step 114 produces a coverability task list comprising tasks for each of the blocks in the solution to the subset cover problem, i.e., blocks B and C. The complete set of coverability tasks contains five tasks, while the subset contains two tasks.

Instrument step 115 instruments the code in SUT 10. This provides a practical way of referring to the blocks in the formulation of the rules. A method for instrumenting the code comprises assigning a value to an auxiliary variable at the start of each block. Table IV below presents sample pseudo-code for SUT 10 representing the control-flow pictured in FIG. 4, together with a possible instrumentation. Statements added to the original code are noted in italics (statements 1, 3, 7, 11, 14, and 17):

| Statement | |
|---|---|
| number | Statements |
| 1. | a=b=c=d=e=0; // declare auxiliary variables |
| 2. | Block A: |
| 3. | a=1; |
| 4. | <statements in Block A> |
| 5. | if (x > 0) |
| 6. | Block B: |
| 7. | b=1 |
| 8. | <statements in Block B> |
| 9. | else |
| 10. | Block C: |
| 11. | c=1; |
| 12. | <statements in Block C> |
| 13. | Block D: |
| 14. | d=1; |
| 15. | <statements in Block D> |
| 13. | <statements in Block E> |

Generate rule list step 116 generates a list of rules from the coverability task list. Referring to the subset of coverability tasks computed from Table III and the instrumentation shown in Table IV, a list of rules shown in Table V below is generated:

TABLE V

| | |
|---|---|
| Rule | Meaning |

| | |
|---|---|
| ! (b == 1) | Variable b never has the value 1, |
| | i.e., block B can never execute |
| ! (c == 1) | Variable c never has the value 1, |
| | i.e., block C can never execute |

A rule from Table V is selected in select rule step 119, e.g. !(b==1). The rule and instrumented code created in step 115 and shown in Table IV are used to generate a finite state machine in generate FSM step 120. In run model checker step 121, the model checker attempts to prove or disprove the proposition of the rule, i.e., that variable b can never have the value 1. Condition 122 checks if run model checker step 121 disproves the rule !(b==1) , meaning that variable b can assume the value 1. If so, the corresponding coverability task (“Block B can execute”)—coverability task 2 of Table III—is considered performed, and is noted as such in step 124. If running the model checker proves the rule true, coverability task 2 of Table III is added to the list of uncoverable elements in step 123. Method 110 continues with condition 118, until both of the rules in Table V have been checked. Then, coverability is computed in compute coverability step 126, comparing the total coverability attained with the coverability task list, and providing the list of uncoverable elements generated in step 123 for evaluation.

In sum, a valid measurement of coverability is produced by running the symbolic model checker only twice, instead of performing five executions, as would be required without the benefit of the dominating blocks analysis. This reduction achieves a significant savings of time and resources. In cases of complex software, where in the prior art coverability analysis may have been infeasible from a practical point of view, such a reduction renders coverability analysis feasible.

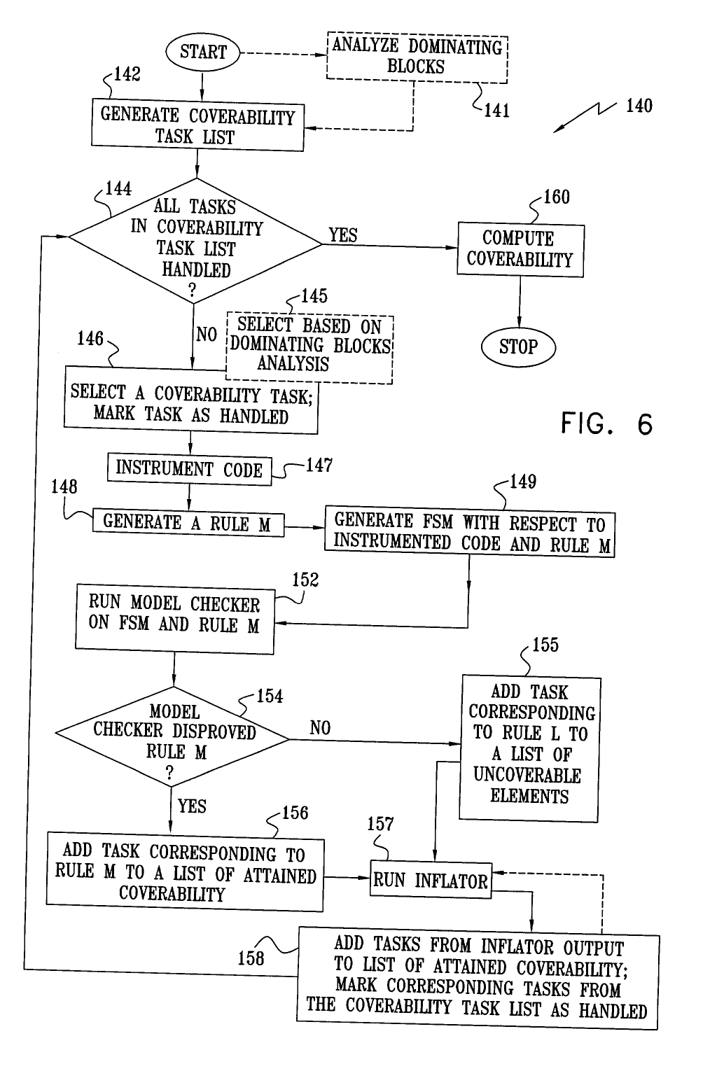

Reference is now made to FIG. 6, which is a flowchart showing a method 140 for optimizing coverability analysis using a dynamic output from a model checker, according to another preferred embodiment of the present invention. Method 140 is implemented as described above for method 110. A coverability task list is generated for all coverability goals in the coverability model, in a generating step 142, substantially as described above for step 114 (FIG. 5). A condition 144 checks if all tasks in the coverability task list have been handled. Initially, all tasks in the coverability task list remain to be handled.

In a select coverability task step 146, a single coverability task is selected randomly from the coverability task list generated in step 142. The selected coverability task is marked as handled.

In an instrument step 148, statements are added to SUT 10 to facilitate formulation and execution of rules, substantially as described above for step 115 (FIG. 5), and with respect to all coverability tasks remaining to be handled in the coverability task list.

In a generate rule step 148, a single rule M is generated for the coverability task selected in step 146, using instrumentation performed in step 148, substantially as described above for step 116 (FIG. 5). A generate FSM step 149 is performed with respect to instrumented SUT 10 and rule M, substantially as described above for step 120 (FIG. 5). In a run model checker step 152, the model checker is executed, substantially as described above for step 120 (FIG. 5). A condition 154 checks the result of symbolic model checker execution 152, and an either an add task to attained coverability step 156 is performed, or an add task to a list of uncoverable elements step 155 is performed, substantially as described above for steps 122, 123, and 124 (FIG. 5).

A run inflator step 157 executes an inflator to produce results for additional variables, outside the cone of influence of rule M. The inflator sets input variables to random values, and computes values for additional values based on the random input variables and the contents of the counter-example or witness. In an add-tasks-from-inflator-output-to-attained-coverability step 158, additional coverability tasks are marked as handled, based on inflator output. Each task added to attained coverability in step 158 is also marked as handled in the coverability task list generated in step 142. Steps 157 and 158 execute whether or not the rule is disproved. Run inflator step 157 and add-tasks-from-inflator-output-to-attained-coverability step 158 may execute one or more times. Control then passes to condition 144, until all coverability tasks identified in step 142 have been handled.

When all coverability tasks in the coverability task list have been handled, condition 144 transfers control to a compute coverability step 160. Computing coverability is performed substantially as described above for step 126 (FIG. 5). Method 140 terminates after step 160.

In the following example illustrating method 140, SUT 10 is assumed to comprise basic blocks {A, B, C, D, E}, substantially as described above in the example for method 110 (FIG. 5). Assuming, as above, a statement coverage model, Table III presents the five coverability tasks generated by step 142. Condition 144 verifies that the list contains tasks not yet handled, and passes control to select coverability task step 146, wherein a coverability task is selected from the list at random and marked as handled. For example, task 4 is selected from Table III: “Prove that Block D can execute.” In instrument step 147, the code of SUT 10 is instrumented as shown in Table IV above. In generate rule step 148, a rule M is generated for the selected coverability task, of the form shown in Table V above: !(d==1). Rule M and instrumented SUT code created in step 147 are used to generate a finite state machine, substantially as described above for step 120 (FIG. 5). In run model checker step 152, the symbolic model checker executes on the FSM created in step 149 and rule M. Condition 154 evaluates the result of run model checker step 152, and adds coverability task 4 from Table III to the list of attained coverability in step 156 if rule M !(d=1) was disproved. Assuming that Block D is not dead code, the output of the symbolic model checker contains a counter-example illustrating a case where the variable d assumed the value 1. If rule M was proven true, meaning that block D is not covetable, block D is added to the list of uncoverable elements in step 155.

Regardless of the truth or falsity of rule M, run inflator step 157 generates plausible values for a, b, c, and e. These additional variables appear in counter-example or witness output, as shown in FIG. 3. In add-tasks-from-inflator-output-to-attained-coverability step 158, the inflated model checker output is analyzed, to determine if other coverability tasks have also been accomplished in the current execution of the model checker. The inflator supplies plausible values for variables a, b, c, and e, for example, a=1, b=0, c=1, and e=1. Using these values, it is possible to mark as attained the additional coverability tasks 1, 3, and 5 from Table III (Blocks A, C, and E can execute). As a consequence, only one coverability task remains to be checked, i.e., coverability task 2 (Block B can execute). Preferably, run inflator step 157 and add-tasks-from-inflator-output-to-attained-coverability step 158 execute one or more times, possibly attaining additional coverability tasks. A valid coverability measurement is computed in step 160 after at most two executions of symbolic model checker 56. As noted above, in cases of complex software, where in the prior art coverability analysis may have been infeasible from a practical point of view, such a reduction renders coverability analysis feasible. This reduction speeds up coverability analysis by a factor approximately equal to a value between two and ten and produces a significant savings of time and resources.

In an alternative preferred embodiment of the present invention static analysis is combined with dynamic analysis. An analyzing step 141 is performed, wherein a set S of dominating blocks for a software under test (SUT) 10 (FIG. 4) is identified and a subset cover problem is solved to produce a subset T comprising {B, C}, by methods known in the art, and substantially as described above for step 112 (FIG. 5). Steps 142 and 144 execute substantially as described above.

In selection step 146, a coverability task is selected from the coverability task list, and the task is marked as handled. A direct selection step 145 directs the selection of the coverability task by making use of information from analysis step 141. Instead of selecting a task to handle at random from among the tasks in the coverability task list, direct selection step 145 guides the selection in order to choose the coverability task with, for example, the largest set of dominated blocks. Steps 148, 150, 152, 154, 156, and 158 execute as described above.

Since the next coverability task to handle is selected on the basis of the extent of its influence on other tasks, i.e., the number of blocks dominated by the subject of the task, it will be appreciated that, using inflator output as described above, the list of coverability tasks left to be handled will decrease more rapidly (step 158). Thus, fewer executions of the symbolic model checker are required to produce a coverability measurement, resulting in savings of time and resources, by a factor of approximately two to ten. As above, where in the prior art coverability analysis may have been infeasible from a practical point of view, such a reduction renders coverability analysis feasible.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for performing coverability analysis in software, comprising:
performing a static analysis of software under test (SUT) so as to identify a plurality of dominating blocks in the SUT;
formulating respective coverability tasks for the dominating blocks of the SUT;
generating rules regarding behavior of the SUT corresponding respectively to the coverability tasks;
for each of the rules, running a symbolic model checker to test a behavioral model of the SUT, so as to produce respective results for the rules; and
computing a coverability metric for the SUT responsive to the results and the coverability tasks.

2. A method according to claim 1, and comprising writing the SUT in a programming language adapted to define at least one of a group of elements comprising a software element and a hardware element.

3. A method according to claim 1, wherein performing the static analysis of the SUT comprises:
identifying a set of dominating blocks in the SUT; and
solving a subset cover problem on the set of dominating blocks so as to identify the plurality of dominating blocks.

4. A method according to claim 3, wherein the set of dominating blocks comprises a set of all dominating blocks in the SUT, and wherein the plurality of dominating blocks comprises fewer blocks than the set of all dominating blocks in the SUT.

5. A method according to claim 4, wherein running the symbolic model checker comprises performing a number of executions of the symbolic model checker smaller than a total number of all the dominating blocks in the SUT.

6. A method according to claim 1, wherein formulating the respective coverability tasks for the dominating blocks of the SUT comprises formulating coverability tasks by at least one of a group of methods comprising manual formulation and automatic formulation.

7. A method according to claim 1, wherein generating the rules regarding behavior of the SUT comprises generating rules by at least one of a group of methods comprising manual generation and automatic generation.

8. A method according to claim 1, wherein running the symbolic model checker to test the behavioral model of the SUT comprises:
evaluating the respective results so as to determine the truth or falsity of the rule; and
generating a list of uncoverable elements responsive to the respective results.

9. A method according to claim 1, wherein generating the rules regarding behavior of the SUT corresponding respectively to the coverability tasks comprises instrumenting the SUT by adding one or more statements and one or more auxiliary variables thereto, so as to facilitate evaluation of the rules.

10. A method according to claim 9, wherein instrumenting the SUT comprises:
determining a plurality of basic blocks comprised in the SUT; and
for each basic block:
defining an auxiliary variable for the block;
initializing the auxiliary variable to zero; and
assigning the auxiliary variable a non-zero value upon execution of the basic block.

11. A method according to claim 9, wherein instrumenting the SUT comprises:
determining a plurality of basic blocks comprised in the SUT;
defining a single auxiliary variable for the SUT;
initializing the single auxiliary variable to zero; and
assigning a unique non-zero value to the single auxiliary variable upon execution of each basic block.

12. A method according to claim 1, wherein computing the coverability metric comprises:
evaluating an attained coverability responsive to the respective results produced by running the symbolic model checker;
evaluating an unattained coverability responsive to the respective results produced by running the symbolic model checker;
performing a comparison between the attained coverability and the coverability tasks;
calculating the coverability metric responsive to the comparison; and
analyzing the behavioral model of the SUT with respect to the unattained coverability.

13. A method according to claim 1, and comprising analyzing a design of the SUT, responsive to the coverability metric, for at least one of a group of properties comprising dead code, unattainable states, uncoverable statements, uncoverable states, unattainable transitions, unattainable variable values, and unreachable conditions.

14. A method according to claim 1, and comprising applying a testing strategy chosen from one of a group of strategies comprising excluding uncoverable elements from coverage measurements, setting coverage goals responsive to the coverability metric, and determining a criterion for stopping testing responsive to the coverability metric.

15. A method according to claim 14, wherein the uncoverable elements comprise one or more elements chosen from a group of elements comprising uncoverable statements, uncoverable states, unattainable transitions, unattainable variable values, and unreachable conditions.

16. A method according to claim 1, wherein formulating the respective coverability tasks for the dominating blocks of the SUT comprises:
identifying a coverage model for the SUT;
defining a coverability model for the SUT responsive to the coverage model; and
generating the respective coverability tasks responsive to the coverability model.

17. A method for performing coverability analysis in software, comprising:
formulating first and second coverability tasks for software under test (SUT);
generating a rule regarding behavior of the SUT corresponding to the first coverability task;
running a symbolic model checker comprising an inflator to test a behavioral model of the SUT responsive to the rule so as to produce an inflated result; and
evaluating the second coverability task responsive to the inflated result.

18. A method according to claim 17, wherein formulating the second coverability task comprises choosing a plurality of coverability tasks from a set of all coverability tasks for the SUT, and wherein evaluating the second coverability task comprises evaluating the plurality.

19. A method according to claim 17, wherein generating the rule regarding behavior of the SUT comprises:
performing a static analysis of the SUT comprising:
identifying a set of dominating blocks in the SUT; and
solving a subset cover problem on the set of dominating blocks so as to produce a plurality of dominating blocks; and
selecting the first coverability task responsive to the plurality.

20. A method according to claim 19, wherein selecting the first coverability task comprises:
identifying a greatest-influence dominating block having a largest set of dominated blocks comprised in the plurality; and
selecting the first coverability task responsive to the greatest-influence dominating block.

21. A method according to claim 19, wherein the set of dominating blocks comprises a set of all dominating blocks in the SUT, and wherein the plurality of dominating blocks comprises fewer blocks than the number of all the dominating blocks.

22. A method according to claim 17, wherein running the symbolic model checker comprises performing a number of executions of the symbolic model checker, wherein the number of executions is smaller than a total number of coverability tasks for the SUT.

23. A method according to claim 17, and comprising writing the SUT in a programming language adapted to define at least one of a group of elements comprising a software element and a hardware element.

24. A method according to claim 17, wherein formulating the first and second coverability tasks for the SUT comprises formulating the tasks by at least one of a group of methods comprising manual formulation and automatic formulation.

25. A method according to claim 17, wherein generating the rule regarding behavior of the SUT comprises generating the rule by at least one of a group of methods comprising manual generation and automatic generation.

26. A method according to claim 17, wherein running the symbolic model checker comprises evaluating the inflated result and determining the truth or falsity of the rule responsive to the evaluation.

27. A method according to claim 17, wherein generating the rule comprises instrumenting the SUT by adding one or more statements and one or more auxiliary variables thereto, so as to facilitate evaluation of the rule.

28. A method according to claim 27, wherein instrumenting the SUT comprises:
determining a plurality of basic blocks comprised in the SUT; and
for each basic block:
defining an auxiliary variable for the block;
initializing the auxiliary variable to zero; and
assigning the auxiliary variable a non-zero value upon execution of the basic block.

29. A method according to claim 27, wherein instrumenting the SUT comprises:
determining a plurality of basic blocks comprised in the SUT;
defining a single auxiliary variable for the SUT;
initializing the single auxiliary variable to zero; and
assigning a unique non-zero value to the single auxiliary variable upon execution of each basic block.

30. A method according to claim 17, wherein running the symbolic model checker comprises producing the inflated result regardless of the truth or falsity of the rule.

31. A method according to claim 17, wherein evaluating the second coverability task responsive to the inflated result, comprises:
evaluating an attained coverability responsive to the inflated result from running the symbolic model checker;
evaluating an unattained coverability responsive to the respective results produced by running the symbolic model checker;
comparing the attained coverability with a plurality of all coverability tasks for the SUT;
calculating a coverability metric responsive to the comparison; and
analyzing the behavioral model of the SUT with respect to the unattained coverability.

32. A method according to claim 31, and comprising analyzing a design of the SUT, responsive to the coverability metric, for at least one of a group of properties comprising dead code, unattainable states, uncoverable statements, uncoverable states, unattainable transitions, unattainable variable values, and unreachable conditions.

33. A method according to claim 31, and comprising applying a testing strategy chosen from one of a group of strategies comprising excluding uncoverable elements from coverage measurements, setting coverage goals responsive to the coverability metric, and determining a criterion for stopping testing responsive to the coverability metric.

34. A method according to claim 33, wherein the uncoverable elements comprise one or more elements chosen from a group of elements comprising uncoverable statements, uncoverable states, unattainable transitions, unattainable variable values, and unreachable conditions.

35. A method according to claim 17, wherein running the symbolic model checker comprises:
performing a plurality of executions of an inflator program so as to produce a plurality of inflated results; and
evaluating the second coverability task responsive to the plurality of inflated results.

36. A method according to claim 17, wherein formulating the first and second coverability tasks for the SUT comprises:
identifying a coverage model for the SUT;
defining a coverability model for the SUT responsive to the coverage model; and
generating the first and second coverability tasks responsive to the coverability model.

37. Apparatus for performing coverability analysis in software, comprising a computing system which is adapted to perform a static analysis of software under test (SUT) so as to identify a plurality of dominating blocks in the SUT, formulate respective coverability tasks for the dominating blocks of the SUT, generate rules regarding behavior of the SUT corresponding respectively to the coverability tasks, run a symbolic model checker to test a behavioral model of the SUT for each of the rules so as to produce respective results for the rules, and compute a coverability metric for the SUT responsive to the results and the coverability tasks.

38. Apparatus for performing coverability analysis in software, comprising a computer system which is adapted to formulate first and second coverability tasks for software under test (SUT), generate a rule regarding behavior of the SUT corresponding to the first coverability task, run a symbolic model checker comprising an inflator to test a behavioral model of the SUT responsive to the rule so as to produce an inflated result, and evaluate the second coverability task responsive to the inflated result.

39. A computer software product for performing coverability analysis in software, comprising a computer-readable medium having computer program instructions recorded therein, which instructions, when read by a computer, cause the computer to perform a static analysis of software under test (SUT) so as to identify a plurality of dominating blocks in the SUT, formulate respective coverability tasks for the dominating blocks in the SUT, generate rules regarding behavior of the SUT corresponding respectively to the coverability tasks, run a symbolic model checker to test a behavioral model of the SUT for each rule so as to produce respective results for the rules, and compute a coverability metric responsive to the results and the coverability tasks.

40. A computer software product for performing coverability analysis in software, comprising a computer-readable medium having computer program instructions recorded therein, which instructions, when read by a computer, cause the computer to formulate first and second coverability tasks for software under test (SUT), generate a rule regarding behavior of the SUT corresponding to the first coverability task, run a symbolic model checker comprising an inflator to test a behavioral model of the SUT responsive to the rule so as to produce an inflated result, and evaluate the second coverability task responsive to the inflated result.
